(19) United States
(12) Patent Application Publication
(10) Pub. No.: US 2014/0046733 A1
(43) Pub. Date: Feb. 13, 2014

(54) Facility Design and Management Systems For Achieving Business Goals

(71) Applicant: CATERPILLAR INC., Peoria, IL (US)

(72) Inventors: Anthony James Grichnik, Eureka, IL (US); Thad Breton Kersh, Dunlap, IL (US); Lonnie Beckwith, Peoria, IL (US); Tyler Eilert Bruns, Champaign, IL (US); Todd William Benanzer, Savoy, IL (US)

(73) Assignee: Caterpillar Inc., Peoria, IL (US)

(21) Appl. No.: 13/827,028

(22) Filed: Mar. 14, 2013

Related U.S. Application Data
(60) Provisional application No. 61/682,475, filed on Aug. 13, 2012.
(60) Provisional application No. 61/682,488, filed on Aug. 13, 2012.
(60) Provisional application No. 61/682,493, filed on Aug. 13, 2012.

(51) Int. Cl. G06Q 10/06

(52) U.S. Cl. CPC G06Q 10/06375
USPC 705/7.37

(57) ABSTRACT

A computer-implemented method for simulating a facility to achieve one or more business goals is disclosed. The method includes receiving, by a processor, one or more input parameters for a discrete event simulator (DES) module for a facility, a plurality of business goals for the facility, and a selection of a goal optimization technique. The method also includes generating, by the processor, a DES output that simulates processes occurring within the facility based on the one or more input parameters and simultaneously achieves the business goals in accordance with the selected goal optimization technique.

This application claims priority to U.S. Provisional Application Nos. 61/682,475, 61/682,488, and 61/682,493, all filed on Aug. 13, 2012. The disclosure of each of the three aforementioned provisional applications is incorporated herein by reference in its entirety.

### TECHNICAL FIELD

The present disclosure relates generally to methods and systems for facility design and management and, more particularly, to methods and systems for facility design and management that achieve one or more business goals associated with the facility.

### BACKGROUND

Simulation tools, such as discrete event simulator (DES) tools may be used to model process flow within a facility, such as a distribution center, warehouse, manufacturing facility, etc. However, conventional DES tools suffer from a variety of problems.

One problem is that while DES tools may provide a great deal of output information regarding the processes that they are simulating, they may not provide guidance on how to change input parameters controlling the DES simulation in order to achieve a proposed set of goals, such as business goals related to a facility. In this case, a human user of the DES tool may be required to manually change the input parameters in an attempt to create a DES simulation result that achieves the desired business goals.

This leads to another problem. If a user is attempting to achieve two or more business goals simultaneously, the input parameter requirements for the business goals may conflict with one another. For example, if a human user is trying to achieve a productivity goal measured by throughput (output X orders in Y time), the user may increase the number of resources (workers, vehicles, equipment, etc.) included as input parameters to the simulation. However, if the user is simultaneously trying to achieve an operating costs goal, the user may desire to decrease the number of resources. Thus, attempting to simultaneously achieve competing business goals may be a difficult and time consuming process with conventional DES tools.

### SUMMARY

In one aspect, the present disclosure is directed to a computer-implemented method for simulating a facility to achieve one or more business goals. The method may include receiving, by a processor, one or more input parameters for a discrete event simulator (DES) module for a facility, a plurality of business goals for the facility, and a selection of a goal optimization technique. The method may also include generating, by the processor, a DES output that simulates processes occurring within the facility based on the one or more input parameters and simultaneously achieves the business goals in accordance with the selected goal optimization technique.

In another aspect, the present disclosure is directed to a system for simulating a facility to achieve one or more business goals. The system may include one or more computer memories storing instructions and one or more computer processors configured to execute the instructions to perform operations. The operations performed by the computer processors may include receiving one or more input parameters for a discrete event simulator (DES) module for a facility, receiving a plurality of business goals for the facility, and receiving a selection of a goal optimization technique. The operations may also include generating a DES output that simulates processes occurring within the facility based on the one or more input parameters and simultaneously achieves the business goals in accordance with the selected goal optimization technique.

In yet another aspect, the present disclosure is directed to a non-transitory computer-readable medium storing computer instructions that, when executed by one or more computer processors, enable the one or more computer processors to perform operations. The operations may include receiving one or more input parameters for a discrete event simulator (DES) module for a facility, receiving a plurality of business goals for the facility, and receiving a selection of a goal optimization technique. The operations may also include generating a DES output that simulates processes occurring within the facility based on the one or more input parameters and simultaneously achieves the business goals in accordance with the selected goal optimization technique.

### BRIEF DESCRIPTION OF THE DRAWINGS

FIG. 1 is a block diagram of an exemplary facility design and management system;

FIG. 2 is a flow chart illustrating an exemplary process that may be performed by the system of FIG. 1 to enable bi-directional communication between DES and CAD modules;

FIG. 3 is an exemplary graphical user interface that may be generated by the system of FIG. 1;

FIG. 4 is a flow diagram illustrating exemplary interaction between modules included in the system of FIG. 1;

FIG. 5 is a block diagram of a topology map including exemplary software objects that may be used by the system of FIG. 1 to simulate movement of material and resources within a facility;

FIG. 6 is a flow chart illustrating an exemplary process that may be performed by the system of FIG. 1 to simulate movement of material and resources within a facility using software objects;

FIG. 7 is a flow chart illustrating another exemplary process that may be performed by the system of FIG. 1 to simulate movement of material and resources within a facility using software objects;

FIG. 8 is a flow chart illustrating an exemplary process that may be performed by the system of FIG. 1 to incorporate business goals into facility planning;

FIG. 9 is a flow chart illustrating an exemplary process that may be performed by the system of FIG. 1 to generate DES instructions for simulating facility operations based on order information;

FIG. 10 is a flow chart illustrating another exemplary process that may be performed by the system of FIG. 1 to generate DES instructions for simulating facility operations based on order information; and

FIGS. 11A-11C are block diagrams illustrating exemplary orders, waves, and bundles.

### DETAILED DESCRIPTION

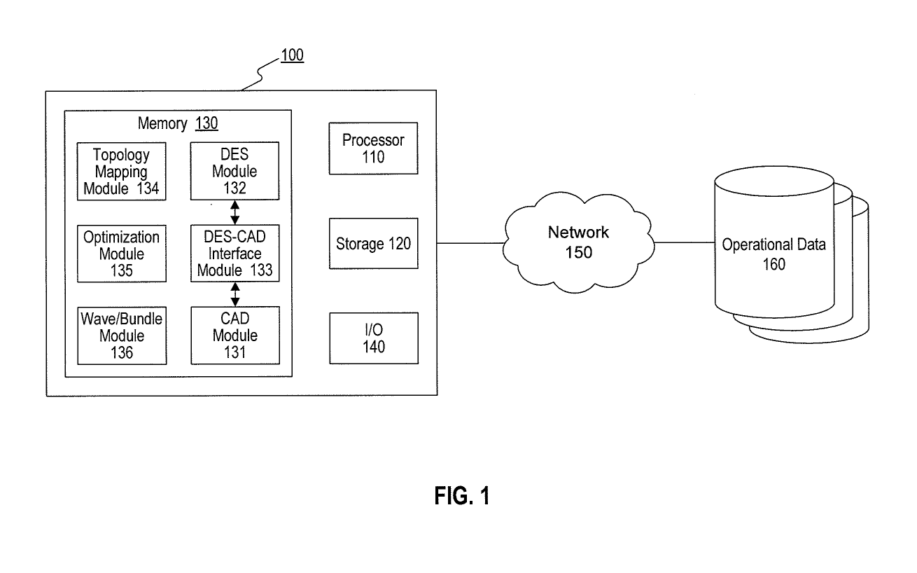

FIG. 1 illustrates an exemplary facility design and management system 100 (hereinafter system 100) in which features and principles consistent with disclosed embodiments may be implemented. System 100 may include a plurality of modules, discussed in greater detail below, that, when executed, facilitate the design and management of a facility such as a distribution center, warehouse, manufacturing facility, etc. While certain exemplary embodiments are discussed in the context of a distribution center, those skilled in the art will appreciate that the embodiments may also be implemented for any other type of facility.

System 100 may include a processor 110, a storage 120, a memory 130, and one or more input/output (I/O) ports 140. Processor 110 may include one or more processing devices, such as one or more microprocessors from the Pentium™ or Xeon™ family manufactured by Intel™, the Turion™ family manufactured by AMD™, or any other type of processors. Storage 120 may include a volatile or non-volatile, magnetic, semiconductor, tape, optical, removable, nonremovable, or other type of storage device or computer-readable medium. Storage 120 may store programs and/or other information, operational data retrieved from operational data databases 160, facility design information, and any other information that may be used by system 100, as discussed in greater detail below. Memory 130 may include one or more storage devices configured to store information used by system 100 to perform certain functions related to the disclosed embodiments.

In one embodiment, memory 130 may include one or more modules (e.g., collections of one or more programs or subprograms) loaded from storage 120 or elsewhere that perform (i.e., that when executed by processor 110, enable processor 110 to perform) various procedures, operations, or processes consistent with the disclosed embodiments. For example, memory 130 may include a CAD module 131, a DES module 132, and a DES-CAD interface module 133. CAD module 131 may generate a representation of the physical structure of the facility. In an example where the facility is a distribution center, the representation may include dimensions of the facility and locations of structures or designated areas within a facility, such as shelving, racks, material staging areas, aisles, docking locations for incoming/outgoing trucks, parking locations for internal vehicles (forklift, etc.), locations for semi-permanent equipment (cranes, etc.), doorways, pillars, machinery footprints, etc. Similar features may be included when configuring a simulation for an assembly facility or factory, while additionally including point-of-use racking, kanban or pull-down storage, kit storage, etc.

DES module 132 may simulate processes occurring within the facility. For example, DES module 132 may simulate the movement of resources (e.g., workers, machines, transportation vehicles, etc.) and material throughout the facility over time. In an example where the facility is a distribution center, DES module 132 may simulate the movement of resources and material as orders for material stored within the distribution center are being filled. The simulated movement may be presented, for example, on a display device in communication with system 100, such that a user of system 100 can view the simulation in two or three dimensions.

In order to simulate processes occurring within the facility, DES module 132 may generate or receive (e.g., from a database, a user via a user interface, etc.) input parameters for the DES simulation in the form of DES data. Some DES data may be related to the location of resources and materials within the facility. For example, DES module 132 may generate or receive DES data representing locations where different materials are stored within the facility, e.g., sorted by part number. DES module 132 may also generate or receive DES data related to the number of resources located at the facility and their general locations. For example, DES module 132 may include DES data representing the number of workers, forklifts, cranes, or other resources. Likewise, DES module 132 may generate or receive DES data related to how those resources move within the facility, e.g., the speed at which a resource moves within the facility, the path a resource is likely to take when moving from point A to point B, etc. DES module 132 may use this information along with one or more DES commands that define different types of processes to be performed in the facility (described in greater detail below) in order to simulate those processes.

DES-CAD interface module 133 may establish a communication link between DES module 132 and CAD module 131 such that when an update occurs to at least one of the representation of the physical structure of the facility generated by the CAD module or the processes simulated by the DES module, DES-CAD interface module 133 automatically communicates the received update to the other module over the communication link. This process, discussed in greater detail below, may enable changes to either the CAD drawings or the DES simulation to be translated to the other module more efficiently, thereby reducing the time it may take to design, re-design, and/or construct a facility.

Memory 130 may also include a topology mapping module 134 that stores or accesses predefined software objects, each of which include DES commands representing processes performed at the facility to be simulated by DES module 132. The software objects of topology mapping module 134, which are discussed in greater detail below, may provide a modular structure for generating DES commands to simulate the movement of resources or materials within a facility. For example, system 100 may receive an instruction to simulate movement of resources or material within the facility, link two or more software objects representing individual processes together, such that the linked software objects together represent the movement to be simulated, and execute the linked software objects using DES module 132 to simulate the movement. The software objects and examples of their use by system 100 are described in greater detail below.

Memory 130 may also include an optimization module 135. As discussed in greater detail below, optimization module 135 may receive output and statistics from DES module 132 regarding one or more DES simulations of the facility (e.g., simulations of the movement of multiple resources and/or materials within the facility to simulate the operation of the facility as a whole) over a particular period (e.g., one day, one week, one month, etc.). Optimization module 135 may also receive one or more business goals (e.g., average inventory level goal, inventory turns goal, work in progress goal, gross revenue goal, net profit goal, build velocity goal, target service level goal, etc.) from a user, database, or elsewhere. In accordance with the embodiments described in greater detail below, optimization module 135 may utilize one or more optimization techniques to modify input parameters to DES module 132 and instruct DES module 132 to generate additional DES simulations of the facility based on the modified input parameters in order to generate a DES simulation that achieves one or more of the business goals simultaneously or nearly simultaneously. Thus, optimization module 135 may enable system 100 to account for the business goals of an organization that is associated with the facility being simulated.

Memory 130 may also include a wave/bundle module 136. Wave/bundle module 136 may receive order information including orders to be processed at the facility and may generate DES commands for fulfilling the orders (i.e., commands that instruct DES module 132 to simulate movement of materials and/or resources within the facility to fulfill the orders). Wave/bundle module 136 may generate the commands in accordance with one or more operational guidelines that control workflow of resources at a facility, as discussed in greater detail below. Moreover, in some embodiments, wave/bundle module 136 may interact with and/or provide inputs to topology mapping module 134 in order to generate the DES commands. In certain embodiments, wave/bundle module 136 may generate, from the orders, multiple waves. A wave includes one or more orders to be filled within a given time period. From each wave, wave/bundle module 136 may generate multiple bundles. A bundle identifies materials from one or more orders that were included in the wave and that are to be processed by one resource within a bundle time period. The operation of wave/bundle module 136 and a more detailed explanation of waves and bundles are described below.

I/O ports 140 may include one or more ports that send and/or receive data from one or more devices or systems. For example, I/O ports 140 may include ports that enable system 100 to receive data from one or more user devices such as a keyboard, mouse, touchscreen, etc. Likewise, I/O ports 140 may include ports that enable system 100 to send data to display information, such as simulation output information, one or more graphical user interfaces, etc., on a display device. I/O ports 140 may also include any other type of data port that enables system 100 to communicate with other systems, such as to retrieve data from operational data databases 160, or any other system.

System 100 may be connected via a network 150 to one or more operational data databases 160. Operational data databases 160 may include one or more distributed databases that include operational data related to a facility. This data may include, for example, data related to inbound or outbound orders for a facility, DES data for the facility, operational guidelines for controlling workflow of resources at the facility, and/or any other data that may be utilized by system 100 in accordance with the disclosed embodiments. Network 150 may include any one of or combination of wired or wireless networks. For example, network 150 may include wired networks such as twisted pair wire, coaxial cable, optical fiber, and/or a digital network. Likewise, network 150 may include any wireless networks such as RFID, microwave or cellular networks or wireless networks employing, e.g., IEEE 802.11 or Bluetooth protocols. Additionally, network 150 may be integrated into any local area network, wide area network, campus area network, or the Internet.

While system 100 is shown in FIG. 1 as a single device, this architecture is exemplary only. Those skilled in the art will appreciate that system 100 may include any number of computing devices, such as one or more computers, servers, etc., that may cooperate to perform the functions described herein with respect to system 100. For example, system 100 may be configured as a distributed system with a plurality of components distributed in remote locations and interconnected by communication paths, such as local area networks, wide area networks, and any other type of network that may facilitate communications and the exchange of information between the components. For example, one such component may execute DES module 132, another component may execute CAD module 131, and still other components may execute optimization module 135, wave/bundle module 136, and/or topology mapping module 134, in order to perform functions consistent with disclosed embodiments.

In certain embodiments, system 100 may establish a communication link between CAD module 131 and DES module 132, using, e.g., DES-CAD interface module 133, as shown in FIG. 1. The communication link may enable bi-directional communication between CAD module 131 and DES module 132, such that updates to one module are automatically translated and transmitted to the other module. By enabling this bi-directional communication, system 100 may facilitate the design, re-design, or construction of a facility by decreasing the time it takes to implement changes or updates made to the CAD drawings and/or the DES simulation, since such changes are automatically transmitted to the other module. In embodiments where CAD module 131 and DES module 132 are included in separate devices, the communication link established by DES-CAD interface module 133 may be established over a network connecting the two devices. In embodiments where CAD module 131 and DES module 132 are included in a single device, the communication link established by DES-CAD interface module 133 may be implemented internally to that device, e.g., in software.

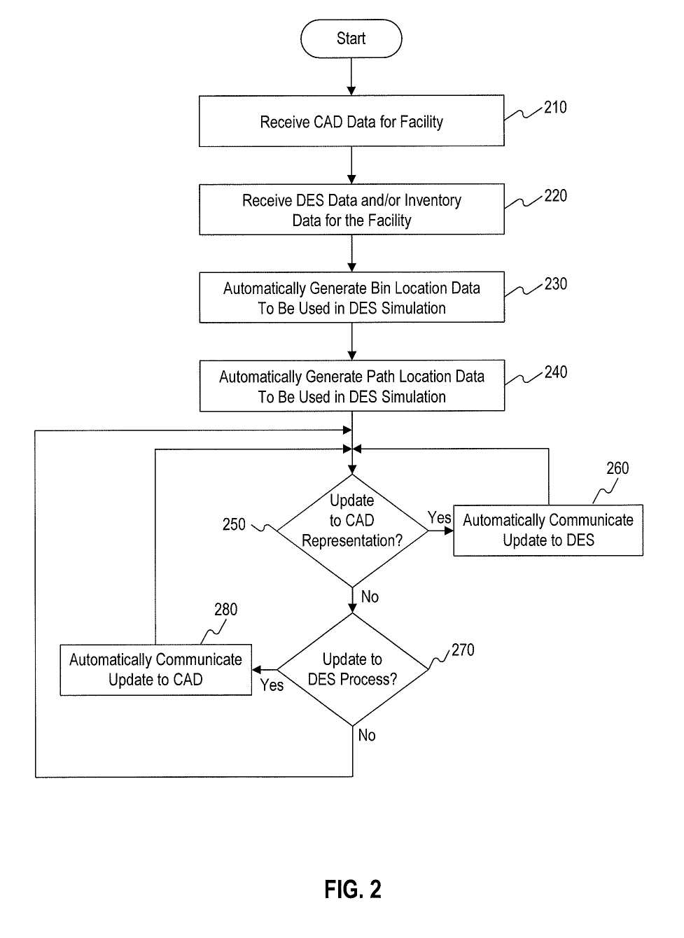

FIG. 2 is a flow chart illustrating an exemplary process that may be performed by system 100 to enable bi-directional communication between CAD module 131 and DES module 132. For example, system 100 may receive CAD data for a facility (step 210), e.g., via CAD module 131. As described above, the CAD data may include data related to the physical structure of the facility. For example, the CAD data may include dimensions of facility and locations of structures or designated areas within a facility, such as shelving, racks, material staging areas, aisles, docking locations for incoming/outgoing trucks, parking locations for internal vehicles (forklift, etc.), locations for semi-permanent equipment (cranes, etc.), doorways, pillars, machinery footprints, etc. In certain embodiments, the received CAD data may be communicated to DES module 132, e.g., via DES-CAD interface module, so that DES module 132 can incorporate the CAD data into the DES simulation.

System 100 may also receive DES data and/or inventory data for the facility (step 220). Exemplary DES data is discussed above. The inventory data may include, for example, information about the materials to be stored at the facility. This information may be provided with varying levels of specificity. For example, in some embodiments, the inventory data may identify individual materials (e.g., by part number or other identifier) as well as an average, expected, or baseline inventory amount for each individual material. The type, size, weight, or other characteristics of each material may also be included in the inventory data. In other embodiments, the inventory data may identify different types of materials (e.g., by size or weight, such as hand-weight parts, fork-truck-weight parts, crane-weight parts) as well as an average, expected, or baseline inventory amount for each of the different types of materials. The DES data and/or inventory data may be input by a user of system 100, e.g., via a graphical user interface (GUI). For example, a user may use GUI 300, discussed in greater detail below, to import one or more files including the DES data and/or inventory data.

Unless it was already included in the received DES data, system 100 may automatically generate bin location data to be used in the DES simulation (step 230). The bin location data may determine where a particular material is stored within the facility. For example, from the CAD data, system 100 has data regarding the locations and sizes of shelving, racks, material staging areas, aisles, etc. Likewise, system 100 has data regarding the locations of cranes and other devices that may be required to lift heavier materials. From the inventory data, system 100 has data regarding the amount of inventory estimated to be on hand for different materials of different types, sizes, and weights. Thus, in an example where the inventory data identifies individual materials and an estimated number of each material in inventory, system 100 may calculate an estimated amount of physical space in the facility to allot for each material. Moreover, system 100 may determine, from the estimated type, size, or weight of the material, what type of shelf, rack, or other storage unit should be used to store the material.

System 100 may take other DES data into account when automatically generating the bin location data. For example, the DES data may include one or more rules or guidelines that system 100 follows when automatically generating the bin location data. According to one exemplary rule, system 100 may be configured to store slow moving materials (materials for which inventory turns are expected to be low or which are not expected to be included frequently in orders) similarly to other slow moving materials, and to store fast moving materials similarly to other fast moving materials. For example, system 100 may be configured to store fast moving materials in a readily accessible part of the facility (e.g., on the ground, at an ideal height for manual handling, at an area of the facility nearer to a shipping or staging area, etc.) and store slower moving materials in lesser accessible parts of the facility (e.g., raised above the faster moving materials, at an area of the facility remote from a shipping or staging area, etc.). System 100 also may incorporate one or more other rules when determining bin locations, e.g., generating bin locations such that materials historically included in a same order are stored together, materials are stored numerically according to part number, etc. In some embodiments, these and other rules may be entered or configured via a user of system 100.

System 100 may also automatically generate path location data to be used in the DES simulation (step 240). For example, DES module 132 may determine an exemplary path along which a resource (e.g., worker, fork truck, etc.) may travel to process (e.g., move, pick, pack, store, ship, etc.) one or more materials. For example, system 100 may be configured to determine that a resource move up and down aisles in a facility using the serpentine pick-path, the down-aisle pick-path, or any other pick-path. Based on the configured path settings, system 100 may determine the path that a resource will take when moving from one location to another location within the facility in order to process one or more materials. Embodiments discussed in greater detail below illustrate how the movements associated with processing the materials in the facility may be converted into DES commands to enable DES module 132 to simulate these movements.

In certain embodiments, DES-CAD interface module 133 may determine that an update has been received to at least one of the representation of the physical structure of the facility generated by CAD module 131 or the processes simulated by DES module 132 and may automatically communicate this update over the communication link established between the two modules. For example, DES-CAD interface module 133 may determine whether an update to the representation of the physical structure of the facility generated by CAD module 131 has occurred (step 250), and, if it has (step 250, Yes), DES-CAD interface module 133 may automatically communicate the update to DES module 132 (step 260). In response to receiving the update, DES module 132 may update, for example, the processes that it simulates, e.g., by updating one or more input parameters of the DES simulation. For example, in certain embodiments, DES module 132 may automatically regenerate bin location data and path location data for the DES simulation (steps 230 and 240) based on the update to CAD module 131.

One example of updating the representation of the physical structure of the facility generated by CAD module 131 that may be detected at step 250 is changing the number of stories included in facility. In this event, DES module 132 may automatically update the processes it simulates to take into account the changed number of stories included in the facility. For example, DES module 132 may regenerate the bin location data and the path location data based on the changed number of stories. This may include, for example, adding or removing one or more ramps, lifts, elevators, etc., to accommodate the changed number of stories and changing path location data to account for the new features. As explained above, DES module 132 may display the results of the simulation via a display device in communication with system 100. Thus, a user may view the DES simulation in a three dimensional rendering that reflects the changed number of stories in the facility.

In certain embodiments, before automatically updating DES module 132 in step 260, DES-CAD interface module 133 may determine whether the update to the representation of the physical structure of the facility generated by CAD module 131 results in a change to the process simulated by DES module 132 that violates a constraint of DES module 132. For example, such an update may reduce the size of the facility to a point where DES module 132 determines that it is too small to hold the expected inventory. In this case, DES-CAD interface module 133 may generate an error message indicating that the update violates a constraint of DES module 132. The error message may be displayed, for example, via a GUI on a display device of system 100, so that the user can interact with one or more of CAD module 131 and DES module 132 to resolve the discrepancy between the two modules.

DES-CAD interface module 133 may also determine whether an update to the processes simulated by DES module 132 has occurred (step 270), and, if it has (step 270, Yes), DES-CAD interface module 133 may automatically communicate the update to CAD module 131 (step 280). In response to receiving the update, CAD module 131 may update its representation of the physical structure of the facility. For example, in certain embodiments, CAD module 131 may alter one or more physical features, such as the size of the facility, or a location of one or more objects within the facility.

In certain embodiments, before automatically updating CAD module 131 in step 280, DES-CAD interface module 133 may determine whether the proposed update to the representation of the physical structure of the facility violates a constraint of CAD module 131. For example, the proposed update may include increasing the size of the facility beyond a maximum size restricted by zoning laws, environmental objects around the facility, etc. Likewise, the proposed update may include moving an entryway or loading dock to an area of the building that is not allowed based on the CAD data. In this case, DES-CAD interface module 133 may generate an error message indicating that the update violates a constraint of CAD module 131. The error message may be displayed, for example, to a user of system 100, so that the user can interact with one or more of CAD module 131 and DES module 132 to resolve the discrepancy between the two modules.

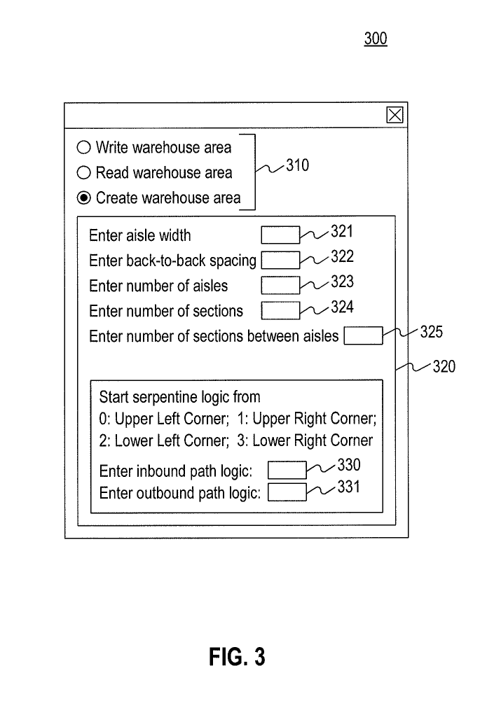

FIG. 3 represents an exemplary GUI 300 that may be displayed on a display device in communication with system 100 to receive updates to the representation of the physical structure of the facility generated by CAD module 131 and/or to the processes simulated by DES module 132. The fields in GUI 300 are exemplary only, and those skilled in the art will appreciate that additional GUIs may be generated to receive additional information from the user regarding updates to CAD module 131 and/or DES module 132.

As shown in FIG. 3, GUI 300 may include Write/Read/Create section 310 that allows a user to save already generated CAD and/or DES data from CAD module 131 and/or DES module 132 to memory (“Write”), import pre-existing CAD and/or DES data from another location, so that CAD module 131 and/or DES module 132 may use the pre-existing data (“Read”), or create new CAD and/or DES data to be used by CAD module 131 and/or DES module 132 (“Create”).

If GUI 300 receives a selection to create new data, GUI 300 may display input section 320 that includes different data entries to enable a user to create the new CAD and/or DES data for the facility. For example, GUI 300 may enable a user to enter CAD data such as aisle widths for aisles within the facility in data entry 321, back-to-back spacing between shelves or other storage components in data entry 322, a number of aisles in a facility or particular location of the facility in data entry 323, a number of sections included in the facility in data entry 324, and a number of section between each set of aisles in the facility in data entry 325. GUI 300 may also enable a user to enter DES data such as pathing preferences that DES module 132 may use to generate path location data for the DES simulation. For example, GUI 300 as shown in FIG. 3 may be configured to use a serpentine pickpath and may enable a user to configure the location at which a resource with inbound materials will enter a group of aisles in data entry 330 and the location at which a resource with outbound materials will enter a group of aisles in data entry 331. As explained, these data entries are exemplary only, and other entries may be included to receive additional or different data, depending on the facility, the processes being simulated, etc.

After receiving the CAD data and/or DES data from GUI 300, CAD module 131 and DES module 132 may interact as described above to generate bin location data, path location data, and ensure that changes to the CAD data are reflected at DES module 132 and that changes to the DES data are reflected at CAD module 131.

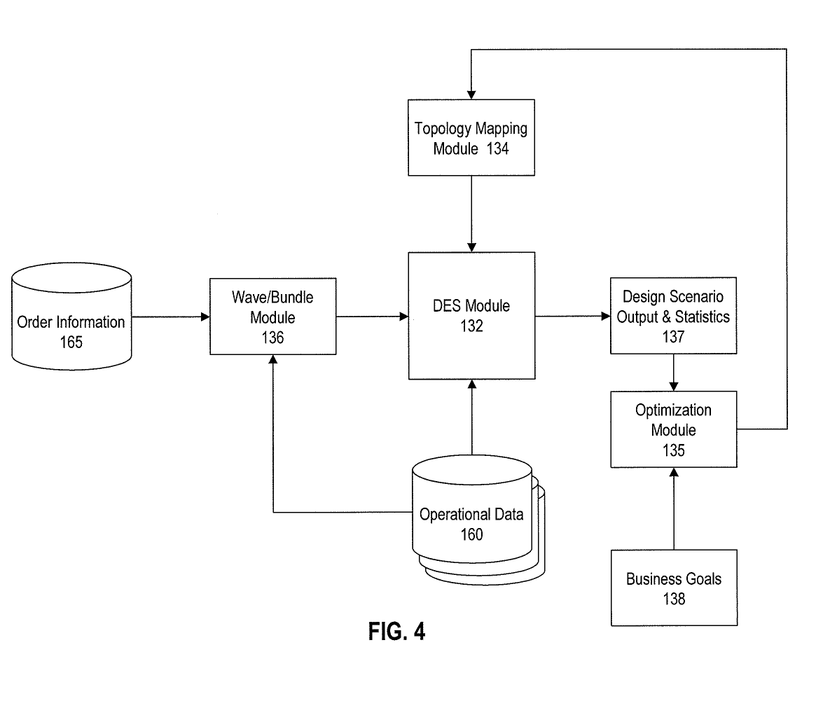

In addition to interacting with CAD module 131 as described above, DES module 132 may also interact with other modules included in system 100 to perform various functions related to disclosed embodiments. FIG. 4 is a flow diagram illustrating exemplary interactions between DES module 132 and topology mapping module 134, optimization module 135, and wave/bundle module 136.

For example, as shown in FIG. 4, DES module 132 may be configured to receive DES commands from topology mapping module 134. As discussed above, topology mapping module 134 may store or access predefined software objects, each of which include DES commands representing a process performed at the facility to be simulated by DES module 132. These software objects may provide a modular structure for generating DES commands to simulate the movement of resources or materials within a facility. In other words, topology mapping module 134 may link together the individual software objects each representing an individual process in order to represent the entire movement of the materials and/or resources to be simulated, and DES module 132 may execute the linked software objects in order to simulate the movement.

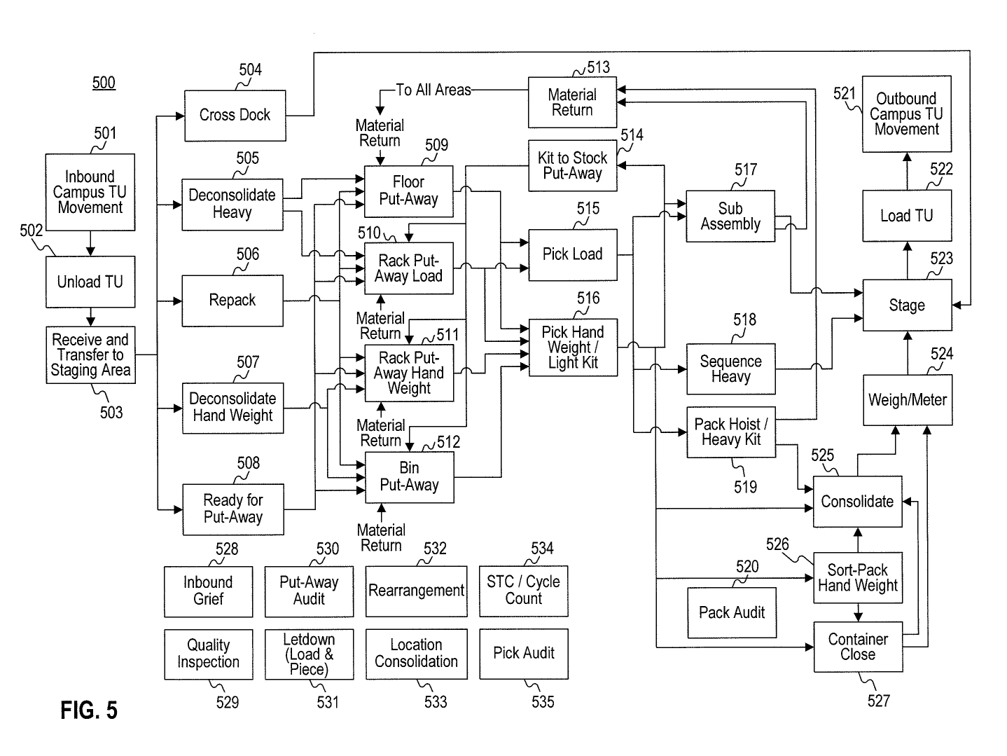

FIG. 5 is a block diagram of a topology map 500 including exemplary software objects that may be accessed and linked together by topology mapping module 134 and then executed by DES module 132 to simulate the movement of material and/or resources within the facility. Topology map 500 includes exemplary software objects 501-535 that each includes one or more DES commands representing a process performed at the facility such that they cause DES module 132 to simulate that particular process. Software objects 501-535 may be created to represent all of the processes that DES module 132 simulates. In this regard, software objects 501-535 shown in FIG. 5 are exemplary only, and any number and type of software object may be predefined and included in topology map 500 based on, for example, the type of facility being simulated (and thus the types of processes being simulated), the number of processes to be simulated at a particular facility, or any other factors.

As shown in FIG. 5, topology map 500 includes arrows indicating associations between particular software objects. The associations may indicate a preferred sequence in which to execute different software objects (i.e., a preferred sequence in which processes are performed at a facility). For example software object 501 includes DES commands to simulate the process of an inbound transportation unit (TU) carrying materials moving from the front gate of the facility to an unloading area of the facility. The arrow from software object 501 indicates that it is associated with software object 502. Software object 502 includes DES commands to simulate resources of the facility unloading the materials from the TU. Because the unloading processes usually follow the TU parking at the unloading area, an association exists in topology map 500 to indicate this general flow between processes.

Topology mapping module 134 may utilize the associations in topology map 500 to link two or more software objects together in order to represent movement of material within the facility and then send the linked software objects to DES module 132 to simulate the movement. For example, topology mapping module 134 may receive an instruction to simulate a cross docking operation within the facility. A cross docking operation generally includes receiving incoming material from a TU at one receiving area and then loading it at another TU in a different shipping area. Thus, to generate DES commands that will simulate this movement, topology mapping module 134 may link together software objects 501, 502, 503, 504, 523, 522, and 521 in that order. Together, the linked software objects include DES commands that simulate an inbound TU carrying materials from the front gate of the facility to an unloading area (software object 501), resources of the facility unloading materials from the TU (software object 502), receiving and documenting the received materials and transferring them to an unloading staging area (software object 503), moving the material through the facility from the unloading staging area to an outgoing staging area (software object 504), the materials waiting at the staging area (software object 523), resources loading the materials onto the TU (software object 522), and an outbound TU carrying materials from the facility (software object 523). Those skilled in the art will appreciate, based on this example, how topology mapping module 134 may link together other combinations of software objects in a similar manner to represent any other types of movement, activity, or processing within the facility.

Some software objects may not be strictly associated with a particular subset of other software objects. For example, some software objects may represent processes that generally occur independently of other processes in the facility or at unexpected or unforeseen times. FIG. 5 includes software objects 520 and 528-535, for example, which are not associated with any other software objects in topology map 500. For example, these software objects include software object 529 that represents a quality inspection of certain materials or equipment within the facility and software object 530 which represents an audit of materials that have been put away on their respective shelves, e.g., to ensure that materials are being stored in their designated locations. These software objects can participate at any point in the chain of activities defined by the other software modules, and can be configured to participate infrequently or randomly within a chain of activities. For instance, software object 529 may be applied periodically to one of every ten cycles of a process, or applied to a randomized draw of 10% of all items passing through the aforementioned chain of software objects.

Each software object may include multiple input variables and multiple output values. The input variables and output values of each software object may vary depending on the process that the software object represents. For example, as discussed above, software object 504 represents the transfer of materials from one location to another. Thus, software object 504 may include as input variables a start location, an end location, and an identification of the material being moved (e.g., by part number). Other input variables may also be included, such as the resource used to move the material. However, in some cases, software object 504 itself may include commands for determining the resource, e.g., based on the type of the material being moved. For example, larger items may require a fork truck while smaller items may only require a worker hand-carrying the item. The output values of software object 504 may include location information of the material (and the resource being used to move the material) over time. For example, as system 100 executes software object 504, it may output the location of the material being moved at several different times, as it is being moved from the start location to the end location. As described below, the level of resolution with which the location is output may be variable based on several different circumstances. For example, as described below, DES module 132 may be configured to output the location of the material with a certain degree of spatial granularity (e.g., measured in yards, feet, inches, etc.) and also with a certain degree of temporal granularity (e.g., output the location information every 10 seconds, second, or fractions thereof).

Moreover, after being linked, each linked software object may use and incorporate output values from the other linked software objects as its own input variables. For example, an output from software object 503 may include the location in which the material to be cross-docked is to be obtained among several inbound staging areas. This location may be used as the start location input variable of software object 504, as discussed above.

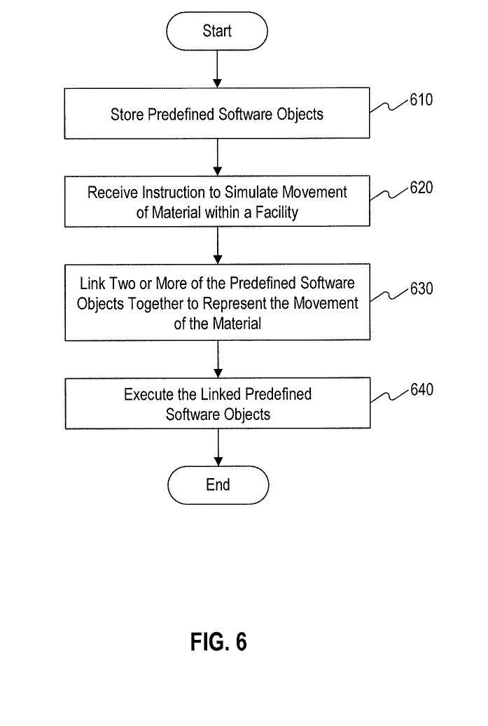

FIG. 6 is a flow chart illustrating an exemplary process that may be performed by system 100 to simulate movement of material within a facility using software objects. For example, system 100 may store multiple predefined software objects (step 610), such as in memory 130, storage 120, or elsewhere. Each of the predefined software objects may include one or more DES commands to represent a process performed at a facility. In certain embodiments, system 100 may store the software objects as a topology map 500 that includes associations among the different software objects.

System 100 may also receive an instruction to simulate movement of a material within a facility (step 620). This instruction may be received from a device external to system 100, e.g., from a user input device, or may be received from one or more modules within system 100. For example, as described below, wave/bundle module 136 may generate instructions to simulate movement within a facility required to fulfill orders for materials received by wave/bundle module 136. Such instruction may include, for example, instructions to pick and pack certain materials to fulfill an order, or may include any other instructions such as the cross docking operation discussed above.

Responsive to receiving the instructions, system 100 may link two or more of the predefined software objects together to represent the movement of the material within the facility (step 630). For example, if the instruction includes the cross docking operation discussed above, topology mapping module 134 of system 100 may link software objects 501, 502, 503, 504, 523, 522, and 521 together so that DES module 132 of system 100 may simulate the cross docking operation by executing the linked predefined software objects in sequence to simulate the movement of the material within the facility (step 640). System 100 may perform the process of FIG. 6 multiple times during a simulation of a facility, in order to simulate movement of multiple different materials and resources within the facility.

The linking of multiple modular software objects as described above my improve the performance of DES module 132. For example, in a conventional DES system, the individual operations represented by the linkage of software objects 501, 502, 503, 504, 523, 522, and 521 would have to be manually coded for every possible variation of inbound dock, staging area, and outbound dock. By contrast, the modular DES architecture of topology map 500 includes these possible combinations and automatically configures permutations of these locations without requiring individual manual coding.

As discussed above, DES module 132 may be configured to execute the software objects and thus provide output values with certain degrees of resolution. Two exemplary types of resolution are spatial granularity (e.g., position measured in yards, feet, inches, etc.) and temporal granularity (e.g., generate the output values every 15 seconds, second, or fractions thereof). Moreover, in certain embodiments, DES module 132 may be configured to execute different software objects with different resolutions during a single simulation of a facility.

In some of these embodiments, DES module 132 may be configured to execute each of the linked software objects representing one type of movement of materials with a first resolution and each of the linked software objects representing another type of movement of materials with a second resolution that is different from the first. For example, if DES module 132 is simulating a facility that includes a first movement including cross docking one material and a second movement including picking, consolidating, and shipping another material, DES module 132 may be configured simulate the two movements with different resolutions. For example, the linked software objects 501, 502, 503, 504, 523, 522, and 521 that represent the cross docking operation may be executed with a first temporal granularity and a first spatial granularity, while the linked software objects 516, 525, 524, 523, 522, and 521 that represent the picking, consolidating, and shipping operation may be executed with a second temporal granularity and a second spatial granularity. The second temporal granularity and/or the second spatial granularity may be different than the first temporal granularity and/or the first spatial granularity, respectively.

In other embodiments, the DES module 132 may be configured to execute each software object, itself, with a different resolution. For example, when simulating the picking, consolidating, and shipping operation described above, DES module 132 may be configured to execute software object 516 with first spatial and temporal granularities and execute software objects 525, 524, 523, 522, and 521 with second spatial and temporal granularities.

In another explanatory example, consider the cross docking operation that may be represented by the linked software objects 501, 502, 503, 504, 523, 522, and 521. In this example, the cross docking operation may be between an inbound dock receiving 40-foot truck trailers and an outbound dock loading and sending out 20-foot ocean containers. In this example, the outbound dock may need to either be twice as large or operate on twice as fast a time scale as the inbound dock to account for the difference in arriving and departing materials. Increasing the size of the outbound dock may require increasing the spatial resolution of software object 522, which simulates loading materials onto the outbound TU. Likewise, increasing the loading velocity at the outbound dock may require increasing the temporal resolution of software object 522. However, because neither decision has any impact on the portion of the simulation represented by the remaining software objects 502, 502, 503, 504, 523, and 521, system 100 may only change the spatial and/or temporal resolution of software object 522, as needed, and not change the resolutions of the other software objects. This may enable system 100 to reduce unnecessary computational overhead.

System 100 may determine the different resolutions (e.g., spatial and temporal granularities) with which DES module 132 executes the different software objects in a variety of ways. In certain embodiments, the system may receive user input, e.g., via a GUI, defining the resolutions for one or more software objects and may determine the resolution for each software object based on the user input. In some embodiments, system 100 may determine the resolution for a particular software object based on the process being simulated by that software object. For example, system 100 may calculate an area of a portion of the facility that is impacted by the first process represented by that software object and determine the resolution based on the calculated area. The area impacted by a process may include, for example, the total area through which a resource travels when performing the movements simulated by the process. In still other embodiments, system 100 may determine the resolution for a particular software object based on the number of times the software object is executed when simulating the facility. For example, as discussed above, system 100 may execute multiple software objects to simulate the movement of multiple materials and resources throughout the facility over a specified time period (e.g., a work day). Thus, system 100 may determine a number of times that it must execute a particular software object to simulate movement of materials within the facility over the specified time period and determine the resolution for that software object based on the calculated number of times that the software object will be executed.

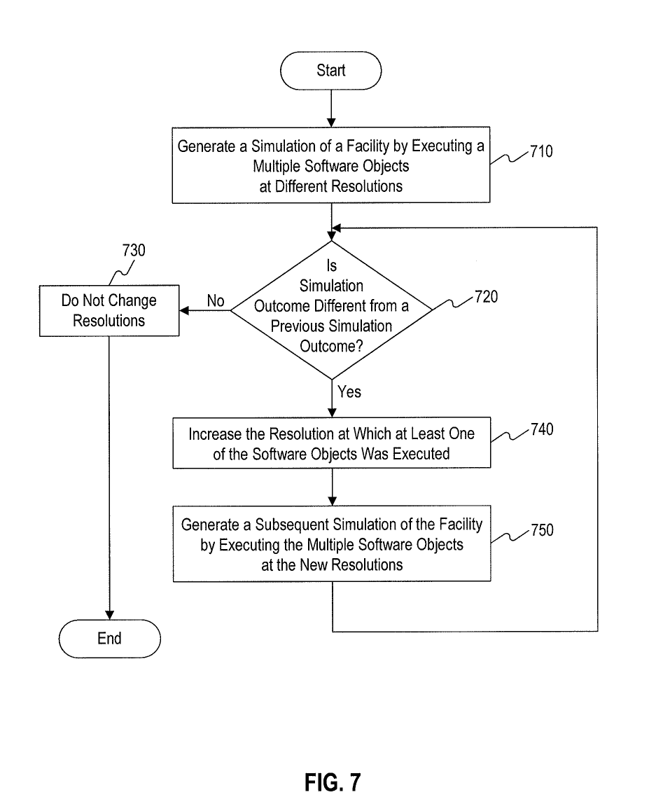

System 100 may also be configured to optimize the resolutions at which to execute one or more of the software objects. FIG. 7 is a flow chart illustrating an exemplary process that may be performed by system 100 to optimize the resolutions. According to the process of FIG. 7, system 100 may generate a first simulation of a facility by executing multiple software objects at different resolutions (step 710). For example, DES module 132 may execute, among other software objects, a first software object at a first resolution and a second software object at a second resolution.

System 100 may also compare the outcome of the first simulation to the outcome of a previous simulation (step 720). The outcome of the simulations may include one or more measurable values. For example, the outcome of the simulations may be represented by various metrics indicative of the efficiency of the facility such as throughput, profit, number of orders fulfilled, percentage of orders fulfilled, etc. The previous simulation may be one that had already been performed, the results of which were stored at system 100. In certain embodiments, the previous simulation may have executed one or more software objects at a lower resolution than the resolution at which those software were executed during the first simulation. Thus, by comparing the two outcomes at step 720, system 100 may determine if increasing the resolution at which one or more of the software objects are executed improves the performance of the DES simulation.

If system 100 determines that the outcome of the first simulation is different than the outcome of the previous simulation (step 720, Yes), system 100 may determine that the increase in resolution improved the performance of the DES simulation. Therefore, system 100 may again increase the resolution at which at least one of the software objects was executed (step 740), to try to further improve the performance of the DES simulation. System 100 may determine which resolutions to increase based on one or more of the factors described above, such as the area impacted by a process represented by a software object, the number of times a software object is executed, etc. For example, in certain embodiments, system 100 may increase the resolution for the software objects representing processes that impact areas of a facility greater than a threshold area, for the software objects that are executed greater than a threshold number of times during a simulation, etc.

System 100 may then generate a second simulation of the facility by executing the multiple software objects at the new resolutions (step 750). System 100 may continue in this manner, iteratively increasing the resolutions if it determines that the current simulation produces a different outcome than a previous simulation. Thus system 100 may stop when it determines that the current simulation and the previous simulation converge. For example, if system 100 determines that the outcome is not different (i.e., that performance has not improved) (step 720, No), then system 100 may determine that the increased resolution is not improving the performance of the DES simulation, and may stop iteratively increasing the resolution.

Returning to FIG. 4, DES module 132 may also communicate with optimization module 135 by outputting design scenario output and statistics 137 to optimization module 135. Design scenario output and statistics 137 may include any measurable outcomes from a DES simulation of a facility being simulated. For example, if the facility is a distribution center, design scenario output and statistics 137 may include inventory data (average inventory during a simulation, inventory turns, etc.), productivity data (total output during the simulation, throughput measured in output per unit time, etc.), cost data (total operating cost, variable cost, fixed cost, etc.), or any other measurable statistics.

In addition to receiving design scenario output and statistics 137, optimization module 135 may also receive one or more business goals 138 related to the facility. Business goals 138 may be entered into system 100 by a user, e.g., via a user device communicatively connected to I/O ports 140. Business goals 138 may include, but are not limited to, profit, return on net assets (RONA), inventory turns, total inventory, service level (percentage of orders filled), total output, throughput measured in output per unit time, total operating cost, variable cost, fixed cost, etc. Business goals 138 may also include target goal values for each business goal 138. For example, the profit business goal 138 may have a target goal value measured in a threshold amount of money, the service level business goal 138 may have a target goal value measured in a threshold percentage of orders filled.

Optimization module 135 may be configured to determine input parameters to a DES simulation that achieve business goals 138. For example, based on the received design scenario output and statistics 137 and business goals 138, optimization module 135 may modify one or more input parameters to the DES simulation of the facility and then instruct DES module 132 to re-run the simulation of the facility with the new input parameters.

As shown in FIG. 4, optimization module 135 may communicate with DES module 132 using topology mapping module 134. In other words, the instructions sent to DES module 132 may be in the form of the modularized software objects discussed above with regard to FIG. 5. As discussed, this may enable more rapid reconfiguration of DES module 132. Thus, optimization module 135 may be able to change input parameters and receive results from DES module 132 more quickly. This may, in turn, enable optimization module 135 to determine input parameters that achieve business goals 138 in less time and with greater precision and reliability than a conventional DES system with a human user. Of course, optimization module 135 is not limited to using the modularized software objects and may instead communicate directly with DES module 132 when appropriate.

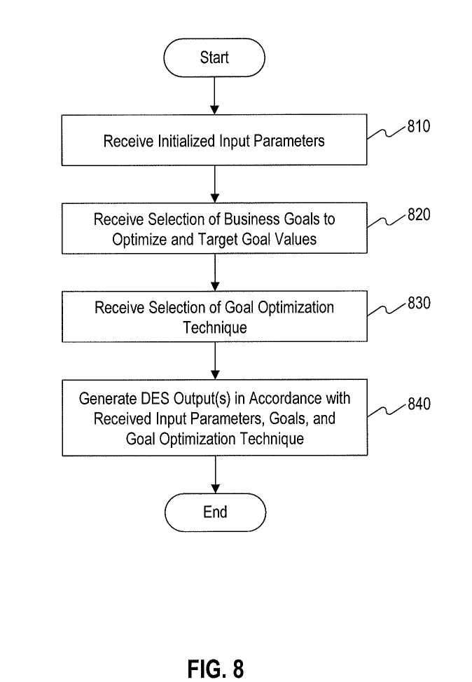

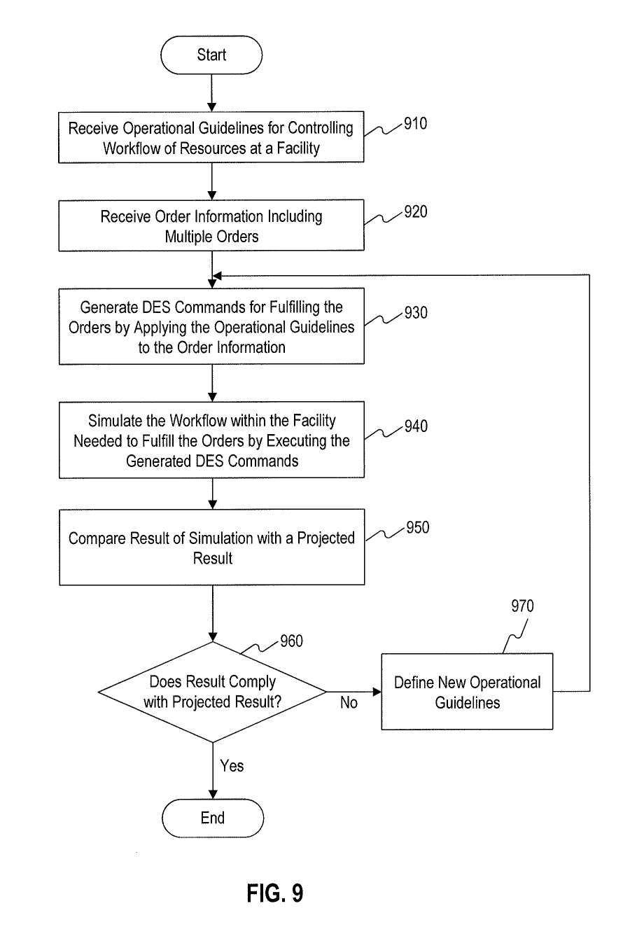

FIG. 8 is a flow chart illustrating an exemplary process that may be performed by system 100 to generate a DES simulation for a facility that achieves business goals 138. According to the process of FIG. 8, system 100 may receive initialized input parameters for DES module 132 (step 810). Collectively, the group of input parameters used to generate a DES simulation output may be referred to as the input space for that particular DES simulation output. These input parameters may be received from a user input device connected to I/O ports 140, for example, or loaded from a memory or storage remote from or local to system 100. The input parameters may include, for example, the CAD and/or DES data discussed above. For example, the input parameters may include a maximum number of workers, forklifts, cranes, or other resources to be included in the simulation. Likewise, the input parameters may control how those resources move within the facility, e.g., the speed at which a resource moves within the facility, the path a resource is likely to take when moving from point A to point B, etc. Alternatively or additionally, the input parameters may also include one or more operational guidelines, such as a maximum number of bundles in a wave, minimum number of materials in a bundle, etc. When such operational guidelines are included, the optimization techniques described with regard to FIG. 8 can be used to change the operational guidelines such that manipulate wave/bundle module 136 alters the wave and bundle size in accordance with those changed operational guidelines, as described below with regard to FIGS. 9-11, in order to achieve one or more business goals.

System 100 may also receive a selection of business goals 138 to optimize along with target goal values for business goals 138 (step 820). For example, as discussed above, a user may enter one or more business goals 138 that the user wants the simulation to achieve (i.e., meet the target goal values for those business goals) via a user device communicatively connected to I/O ports 140.

System 100 may also receive a selection of a goal optimization technique (step 830). The goal optimization technique may define a process that system 100 uses to simultaneously achieve all of business goals 138 received in step 820. Exemplary goal optimization techniques that system 100 may receive and implement include superposition techniques, incremental solving techniques, goal synthesis techniques, and exploration techniques. Each of these exemplary goal optimization techniques is described in greater detail below.

System 100 may then generate DES output(s) (e.g., using DES module 132) in accordance with the received input parameters, business goals 138, and goal optimization technique (step 840). The goal optimization technique received in step 830 may determine the manner in which system 100 performs step 840. Thus, the functions of system 100 during step 840 are discussed below for each of the four exemplary goal optimization techniques.

If a superposition technique was selected at step 830, system 100 may generate separate preliminary DES outputs that optimize each one of business goals 138, and then combine the input spaces that produced each of the preliminary DES outputs to generate a combined input space that generates the final DES output. For example, optimization module 135 may vary the input parameters used by DES module 132 such that DES module 132 generates a simulation of the facility that optimizes a first business goal 138. This process may require multiple iterations, as optimization module 135 varies the input parameters multiple times in order to determine the set of input parameters (i.e., the input space) that optimizes the first business goal 138. Then, optimization module 135 may use the same process to determine the set of input parameters (i.e., the input space) that optimizes a second business goal 138, and any remaining business goals 138 that were received at step 820.

After determining the sets of input parameters that generate DES outputs optimizing each business goal 138 individually, optimization module 135 may combine the input spaces to determine a set of input parameters that collectively achieve all of the business goals 138. For example, optimization module 135 may search for commonalities among the individual sets of input parameters and may determine the final, combined input parameters based on the commonalities. If all, or a majority, of the preliminary DES simulations required at least X number of a particular resource, for example, then optimization module 135 may determine that the input parameter for that resource should be at least X. Likewise, if all, or a majority, of the preliminary DES simulations used a particular pathing logic, such as the serpentine pick-path, then optimization module 135 may determine that the input parameter for the pathing logic should be the same for the final DES simulation.

If an incremental solving technique was selected at step 830, system 100 may first generate a DES simulation of the facility that optimizes a first business goal 138, as discussed above. Then, system 100 may determine a refined input space to generate a DES simulation of the facility that optimizes a second business goal 138, using at least one input parameter from the DES simulation that optimized the first business goal 138. This process may repeat for all remaining business goals 138. For example, if three business goals 138, operating cost, productivity, and inventory turns, were received, system 100 may first determine a DES output and corresponding input parameters that optimize operating cost. System 100 may fix one or more of the input parameters from the DES simulation that optimized operating cost, and then vary the remaining input parameters that were not fixed to generate a DES output that optimizes productivity. After optimizing productivity, system 100 may fix one or more additional input parameters, and then vary the remaining input parameters that were not fixed from optimizing operating cost and productivity to generate a DES output that optimizes inventory turns.

Using this method, system 100 may incrementally determine input parameters to create a DES output that achieves business goals 138. System 100 may implement incremental solving, for example, when optimizing one or more of business goals 138 is computationally expensive and optimizing one or more other business goals 138 is not. In the example discussed above, inventory turns may be computationally expensive to optimize, because DES module 132 must simulate the movement of materials within the facility over a relatively long period of time (e.g., weeks, months, etc.) in order to accurately estimate the inventory turns that will be achieved for a given set of input parameters. On the other hand, operating cost may not be as computationally expensive because DES module 132 may be able to accurately estimate an operating cost value by simulating a much shorter period of time (e.g., a day, fraction of a day, etc.). Thus, when using incremental solving, system 100 may optimize business goals 138 in the order of computational cost from least computationally expensive to most computationally expensive.

If, on the other hand, a goal synthesis technique was selected at step 830, system 100 may combine the received business goals 138 to create a composite business goal, and then determine input parameters to generate a DES output that optimizes the composite business goal. For example, the composite business goal may be an average or weighted average of the received business goals 138, or any other combination of the received business goals 138. System 100 may then generate one or more candidate input spaces to be processed by DES module 132 in order to generate a DES output from DES module 132 that optimizes the composite business goal. The candidate input spaces may be determined using techniques such as a genetic algorithm, gradient descent solver, ant colony optimization technique, etc.

If an exploration technique was selected at step 830, system 100 may generate multiple preliminary DES outputs using multiple different inputs spaces and select one of the preliminary DES outputs as the DES output. In this case, the different input parameters used to generate each of the multiple preliminary DES outputs may be chosen randomly by system 100 or by some other method, such as a resolution surface map form of a designed experiment. In order to select the DES output from the preliminary DES output, system 100 may first select, for each business goal 138, a preliminary DES output from among the plurality of preliminary DES outputs that includes the best result for that business goal 138. Then, system 100 may select the DES output as one of the preliminary DES outputs that most closely matches each of the preliminary DES outputs providing the best result for a particular business goal 138. In other words, system 100 may select the DES output as the preliminary DES output that is the most proximal to each of the preliminary DES outputs providing the best result for one business goal 138 measured in an n-dimensional output space, where each input parameter is one of the n dimensions. In some cases, the most proximal preliminary DES output may be the one with the minimum average distance from each of the preliminary DES outputs measured in the n-dimensional output space.

Using one of the exemplary optimization techniques discussed above, system 100 in step 840 may determine a set of input parameters that achieves the business goals 138 provided to system 100, even when business goals 138 are conflicting. Thus, when designing a facility, an organization can determine a number of resources and/or other functions or processes to include in the facility in order to ensure that the facility operates within a particular set of business goals 138.

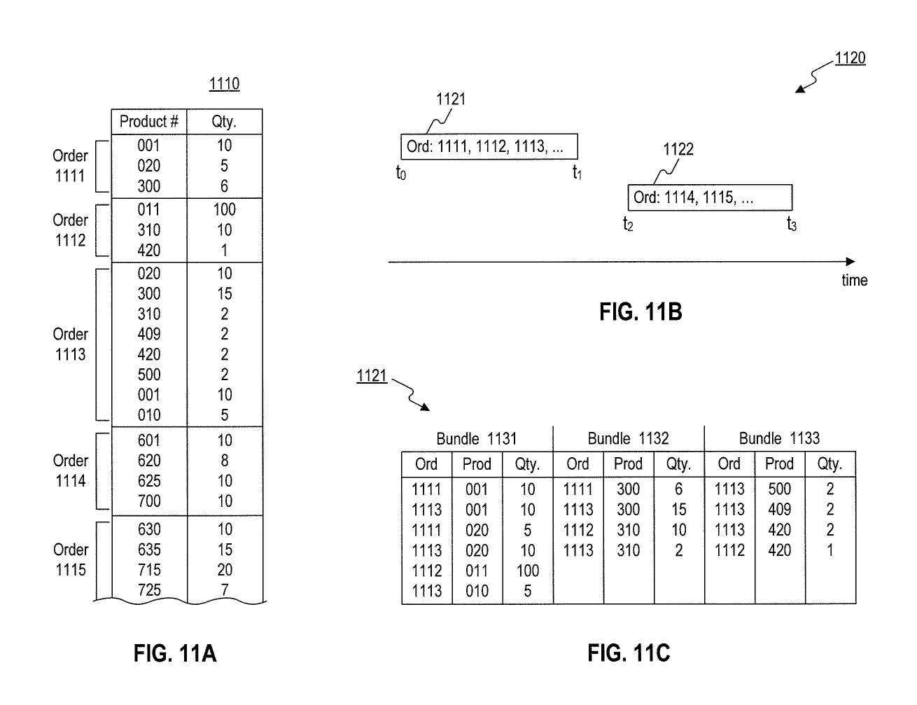

Returning to FIG. 4, DES module 132 may also communicate with wave/bundle module 136 during the operation of system 100. As shown in FIG. 4, wave/bundle module 136 may receive order information from order information database 165 including orders to be processed at the facility and may generate DES commands for fulfilling the orders (e.g., commands that instruct DES module 132 to simulate movement of materials and/or resources within the facility to fulfill the orders). Wave/bundle module 136 may generate the commands in accordance with one or more operational guidelines that it may receive, e.g., from operational data databases 160. The operational guidelines control workflow of resources at a facility and may include, for example, a maximum number of bundles that can be included in a wave or a minimum number of materials that can be included in a bundle. In general, a wave includes one or more orders to be filled within a given time period. From each wave, wave/bundle module 136 may generate multiple bundles. A bundle identifies materials from one or more orders that were included in the wave and that are to be processed by one resource within a bundle time period. Waves and bundles are described in greater detail below with respect to FIGS. 11A-11C. The operational guidelines may also include any other guidelines to control workflow of resources at a facility, such a sequence in which particular orders are processed, picking preferences for how materials are to be processed (e.g., via pick-pack methods, pack-consolidate methods, pack-deconsolidate methods, etc.).

FIG. 9 is a flow chart illustrating an exemplary process that may be performed by system 100 to generate DES instructions for simulating facility operations based on order information from order information database 165. System 100 may receive operational guidelines for controlling the workflow of resources at a facility (step 910). For example, a user may define one or more operational guidelines (e.g., maximum number of bundles in a wave, minimum number of materials in a bundle, etc.) and send these operational guidelines to wave/bundle module 136 of system 100, e.g., via a user device communicatively connected to system 100 via I/O ports 140. Additionally, as discussed above, the one or more operational guidelines may be determined by optimization module 135 such that maximum number of bundles in a wave, minimum number of materials in a bundle, etc., are determined in a manner that optimizes one or more business goals.

System 100 may also receive order information including multiple orders, e.g., from order information database 165 (step 920). The order information may contain any combination of historical, predicted, or actual order data. For example, if a user is using system 100 to design a facility, the user may instruct system 100 to retrieve historical order information from a similarly situated facility that is already in operation or may generate and store in order information database 165 predicted order information based on the predicted number and type of orders to be processed by the facility being designed. A user may also use system 100 to manage a facility in real-time, e.g., in order to determine whether an already existing facility will be able to process a particular number of orders. In this case, system 100 may retrieve actual order data from order information database 165. For example, a supervisor of a facility may use system 100 to simulate the orders that will be processed at that facility during the next working day. This may allow the supervisor to ensure that all orders will be processed and to change one or more operational parameters, if needed, to improve the efficiency of the facility for the next day.

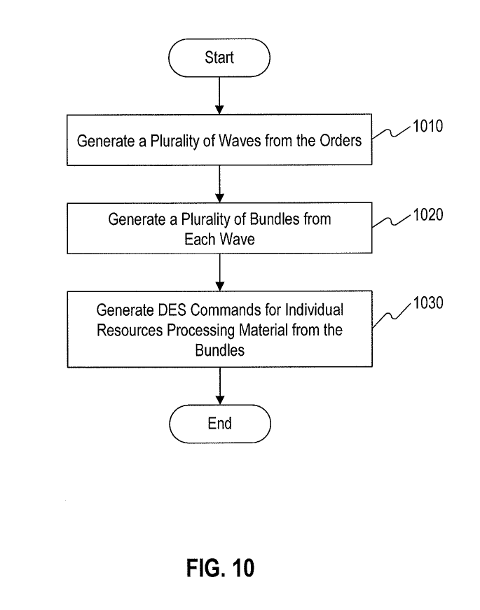

After receiving the order information, wave/bundle module 136 of system 100 may generate DES commands for fulfilling the orders by applying the operational guidelines to the order information (step 930). FIG. 10 is a flow chart illustrating an exemplary process that wave/bundle module 136 may perform to generate the DES instructions as a part of step 930.

For example, wave/bundle module 136 may generate a plurality of waves from the orders included in the order information (step 1010). As discussed, a wave includes one or more orders to be filled within a given time period. FIGS. 11A and 11B illustrate how wave/bundle module 136 may divide the orders included in the order information into a plurality of waves as part of step 1010. For example, FIG. 11A illustrates order information 1110 that may have been retrieved from order information database 165. Order information 1110 includes orders 1111-1115, among other orders (which are not shown for simplicity). Each order may include an identification of one or more materials (e.g., by product number) and an identification of the quantity of each material. As shown, order 1111 includes three products and the respective quantity ordered for each product. The format shown in FIG. 11A is, of course, exemplary, and has been simplified for illustration purposes. Any format for order information 1110 may be used by system 100.

Wave/bundle module 136 may divide orders 1111-1115, and the other orders, into a plurality of waves as shown in FIG. 11B. For example, wave 1121 includes orders 1111, 1112, and 1113, among other orders, and is to be processed in the facility between time t₀ and time t₁, while wave 1122 includes orders 1114 and 1115, among other orders, and is to be processed in the facility between time t₂ and time t₃. Wave/bundle module 136 may determine which orders are included in which waves based on a number of criteria, such as operational data restricting the number of bundles that can be included in each wave, times that a particular order must be fulfilled (e.g., if order 1 must ship by t₁, then it must be included in wave 1121 and cannot be included in wave 1122), sorting orders with like materials together, (e.g., the orders in wave 1122 both include 600-level and 700-level part numbers, which according to some numbering schemes may indicate that the materials have a similar size, shape, or other handling requirement), etc.

Wave/bundle module 136 may also generate a plurality of bundles from each wave generated in step 1010 (step 1020). As discussed, a bundle identifies materials from one or more orders that were included in the wave and that are to be processed by one resource (e.g., worker, automated fork truck, etc.) within a bundle time period. FIGS. 11B and 11C illustrate how wave/bundle module 136 may generate a plurality of bundles from an exemplary wave. For example, FIG. 11B illustrates wave 1121 including orders 1111, 1112, 1113, and other orders. FIG. 11C illustrates exemplary bundles 1131, 1132, and 1133 that may be generated from wave 1121 (FIG. 11C shows only the materials from orders 1111, 1112, and 1113 for simplicity). Wave/bundle module 136 may determine which materials are included in which bundles based on a number of criteria, such as operational data requiring at least a minimum number of materials to be included in each bundle, grouping like materials together (e.g., materials that have a similar size, shape, or other handling requirement), grouping materials together based on their storage location in the facility (e.g., include materials that are stored near each other in the same bundle), etc.

Each bundle may be required to be processed within a predetermined bundle time. For example, if different resources are each assigned to bundles 1131, 1132, and 1133, then each resource may be required to process that particular bundle by time t₁, the end of wave 1121 in which all of bundles 1131, 1132, and 1133 are included. If, on the other hand, one resource is assigned to both bundle 1132 and bundle 1133, then that resource may be required to process bundle 1132 by a time before time t₁ so that the resource can also process bundle 1133 by time t₁.

Wave/bundle module 136 may also generate DES commands for individual resources processing the material from the bundles generated in step 1020. The DES commands for the individual resources may include a chronological list of actions performed in order to process the material from the one or more orders. Using bundle 1133 of FIG. 11C as an example, wave/bundle module 136 may generate DES commands that will simulate a resource processing the four lines in bundle 1133. In certain embodiments, wave/bundle module 136 may utilize topology mapping module 134 to generate the DES commands for each resource. For example, topology mapping module 134 may use topology map 500 described above to link together a plurality of software objects, each representing an individual process performed by the resource, in order to simulate each movement of the resource and the materials being processed throughout the facility when fulfilling the four lines included in bundle 1133. Wave/bundle module 136 may generate similar DES commands for all of the generated bundles.

Returning to FIG. 9, after wave/bundle module 136 (and, in some embodiments, in conjunction with topology mapping module 134) sends the DES commands to DES module 132, DES module 132 may simulate the workflow within the facility needed to fulfill the orders by executing the generated DES commands it receives (step 940). Thus, DES module 132 may generate a simulation of the movement of resources and materials within the facility that will occur over a particular time period while the orders are being fulfilled.

As discussed, system 100 may enable a user to simulate movement within a facility required to process orders so that the user may ensure that all orders will be processed. If all of the orders are not processed, or if any other result from the DES simulation, such as one or more design scenario output and statistics 137 are unsatisfactory, system 100 may enable a user to change one or more operational parameters and re-run the DES simulation. Moreover, system 100 may be configured to automatically change one or more of the operational parameters and re-run the DES simulation without user input. For example, system 100 may compare a result of the simulation in step 940 with a projected result (step 950).

Based on the comparison, system 100 may determine whether the result complies with (e.g., meets or outperforms) the projected result (step 960). If it does not (step 960, No), system 100 may define new operational guidelines based on the comparison (step 970). For example, system 100 may change the maximum number of bundles to be included in a wave, the minimum number of materials to be included in a bundle, or any other operational guideline discussed above.

System 100 may then repeat steps 930-960 for the new operational guidelines, and may continue in this manner until it determines a set of operational guidelines that produce a DES simulation result that complies with the projected result (step 960, Yes), at which point the process ends.

### INDUSTRIAL APPLICABILITY

The disclosed systems and methods may be applicable to any simulation tools, such as DES tools used to model processes within a facility. The disclosed systems and methods may be particularly applicable to an organization that is designing a facility and desires to ensure that the facility will operate at a capacity sufficient to achieve one or more business goals that the organization has for the facility.

For example, the disclosed systems and methods may receive multiple business goals for a facility and determine a set of input parameters to achieve the business goals, even if those business goals conflict with each other. Thus, the disclosed systems and methods may provide an organization with a plan for designing and managing a facility to ensure that it contributes to the organization's success. Moreover, by being capable of implementing multiple different optimization techniques and of implementing a modularized software object-based DES simulation, the disclosed systems and methods may quickly and efficiently generate the set of input parameters that achieves these business goals. As a result, the disclosed systems and methods may decrease the time it takes to design a facility that will achieve the business goals.

It will be apparent to those skilled in the art that various modifications and variations can be made to the disclosed system. Other embodiments will be apparent to those skilled in the art from consideration of the specification and practice of the disclosed system. Moreover, while several embodiments have been described herein, those skilled in the art will appreciate that one or more disclosed embodiments may be combined with one or more other disclosed embodiments. It is intended that the specification and examples be considered as exemplary only, with a true scope being indicated by the following claims and their equivalents.

What is claimed is:

1. A computer-implemented method comprising:
receiving, by a processor, one or more input parameters for a discrete event simulator (DES) module for a facility;
receiving, by the processor, a plurality of business goals for the facility;
receiving, by the processor, a selection of a goal optimization technique; and
generating, by the processor, a DES output that simulates processes occurring within the facility based on the one or more input parameters and simultaneously achieves the business goals in accordance with the selected goal optimization technique.

2. The computer-implemented method of claim 1, wherein the business goals include two or more from the group consisting of: a productivity goal, a variable cost goal, a fixed cost goal, an operating cost goal, and an inventory goal,

3. The computer-implemented method of claim 1, wherein generating the DES output in accordance with the selected goal optimization technique includes:
generating, for each one of the plurality of business goals, a preliminary DES output that optimizes the one of the plurality of business goals; and
combining input spaces used to generate each of the preliminary DES output solutions to generate the DES output.

4. The computer-implemented method of claim 1, wherein generating the DES output in accordance with the selected goal optimization technique includes:
generating, for a first of the plurality of business goals, a preliminary DES output that optimizes the first of the plurality of business goals; and
generating, for the second of the plurality of business goals, a refined DES input space, resulting in a refined DES output that optimizes the second of the plurality of business goals and incorporates at least one input parameter used to generate the preliminary DES output.

5. The computer-implemented method of claim 1, wherein generating the DES output in accordance with the selected goal optimization technique includes:
combining the plurality of business goals to create a composite business goal; and
generating one or more candidate input spaces to generate a DES output that optimizes the composite business goal.

6. The computer-implemented method of claim 1, wherein generating the DES output in accordance with the selected goal optimization technique includes:
generating a plurality of preliminary DES outputs using a plurality of DES input spaces;
selecting, for each business goal, a preliminary DES output from among the plurality of preliminary DES outputs that includes the best result for that business goal; and
selecting, as the DES output, one of the plurality of preliminary DES outputs that is most proximal in an output space to the preliminary DES outputs selected for each business goal.

7. The computer-implemented method of claim 1, further including:
receiving information corresponding to a change in one or more of the input parameters; and
automatically regenerating the DES output based on the changed input parameters.

8. The computer-implemented method of claim 1, further comprising:
generating the DES output using one or more defined software objects each representing a process occurring within the facility.

9. The computer-implemented method of claim 8, wherein each of the one or more software objects includes information regarding one or more of path information, storage information, or process flow information associated with the processes occurring within the facility.

10. A system for simulating a facility to achieve one or more business goals, the system comprising:
one or more computer memories storing instructions; and
one or more computer processors configured to execute the instructions to perform operations including:
receiving one or more input parameters for a discrete event simulator (DES) module for a facility;
receiving a plurality of business goals for the facility;
receiving a selection of a goal optimization technique; and
generating a DES output that simulates processes occurring within the facility based on the one or more input parameters and simultaneously achieves the business goals in accordance with the selected goal optimization technique.

11. The system of claim 10, wherein the business goals include two or more from the group consisting of: a productivity goal, a variable cost goal, a fixed cost goal, an operating cost goal, and an inventory goal,

12. The system of claim 10, wherein the one or more computer processors are further configured to generate the DES output in accordance with the selected goal optimization technique by:
generating, for each one of the plurality of business goals, a preliminary DES output that optimizes the one of the plurality of business goals; and
combining input spaces used to generate each of the preliminary DES output solutions to generate the DES output.

13. The system of claim 10, wherein the one or more computer processors are further configured to generate the DES output in accordance with the selected goal optimization technique by:
generating, for a first of the plurality of business goals, a preliminary DES output that optimizes the first of the plurality of business goals; and
generating, for the second of the plurality of business goals, a refined DES input space, resulting in a refined DES output that optimizes the second of the plurality of business goals and incorporates at least one input parameter used to generate the preliminary DES output.

14. The system of claim 10, the one or more computer processors are further configured to generate the DES output in accordance with the selected goal optimization technique by:
combining the plurality of business goals to create a composite business goal; and
generating one or more candidate input spaces to generate a DES output that optimizes the composite business goal.

15. The system method of claim 10, wherein the one or more computer processors are further configured to generate the DES output in accordance with the selected goal optimization technique by:
generating a plurality of preliminary DES outputs using a plurality of DES input spaces;
selecting, for each business goal, a preliminary DES output from among the plurality of preliminary DES outputs that includes the best result for that business goal; and
selecting, as the DES output, one of the plurality of preliminary DES outputs that is most proximal in an output space to the preliminary DES outputs selected for each business goal.

16. The system of claim 10, wherein the one or more computer processors are further configured to:
receive information corresponding to a change in one or more of the input parameters; and
automatically regenerate the DES output based on the changed input parameters.

17. The system of claim 10, wherein the one or more computer processors are further configured to:
generate the DES output using one or more defined software objects each representing a process occurring within the facility.

18. The system of claim 8, wherein each of the one or more software objects includes information regarding one or more of path information, storage information, or process flow information associated with the processes occurring within the facility.

19. A non-transitory computer-readable medium storing computer instructions that, when executed by one or more computer processors, enable the one or more computer processors to perform operations including:
receiving one or more input parameters for a discrete event simulator (DES) module for a facility;
receiving a plurality of business goals for the facility;
receiving a selection of a goal optimization technique; and
generating a DES output that simulates processes occurring within the facility based on the one or more input parameters and simultaneously achieves the business goals in accordance with the selected goal optimization technique.

20. The non-transitory computer-readable medium of claim 19, the computer instructions further enabling the one or more computer processors to perform operations including:
generating the DES output using one or more defined software objects each representing a process occurring within the facility, wherein each of the one or more software objects includes information regarding one or more of path information, storage information, or process flow information associated with the processes occurring within the facility.
